(19) United States
(12) Patent Application Publication
(10) Pub. No.: US 2023/0270147 A1
(43) Pub. Date: Aug. 31, 2023

(54) FLAVOR DELIVERY SYSTEM, METHOD OF MAKING THE FLAVOR DELIVERY SYSTEM, AND FOOD PRODUCT CONTAINING THE FLAVOR DELIVERY SYSTEM

(71) Applicant: Givaudan SA, VERNIER (CH)

(72) Inventor: Stephen A. FERGUSON, Cincinnati, OH (US)

(21) Appl. No.: 18/114,512

(22) Filed: Feb. 27, 2023

Related U.S. Application Data
(60) Provisional application No. 63/314,951, filed on Feb. 28, 2022.

(51) Int. Cl. A23L 27/00; A23L 25/00; A23L 27/12; A21D 2/16; A21D 2/36

(52) U.S. Cl. CPC A23L 27/72; A23L 25/30; A23L 27/12; A21D 2/165; A21D 2/364; A21D 2/36

(57) ABSTRACT

A flavor delivery system including comminuted seeds, comminuted nuts, or mixtures thereof and a liquid flavor. A method for protecting a liquid flavor from oxidation by combining the liquid flavor with comminuted seeds, comminuted nuts, or mixtures thereof. A method for making a food product including adding a flavor delivery system including comminuted seeds, comminuted nuts, or mixtures thereof and a liquid flavor to an edible base. A food product including a flavor delivery system including comminuted seeds, comminuted nuts, or mixtures thereof, and a liquid flavor, and an edible base.

### TECHNICAL FIELD

The present disclosure is directed to a flavor delivery system, a method for preparing a flavor delivery system, a food product containing the flavor delivery system, and a method for preparing the food product containing the flavor delivery system.

### BACKGROUND

Liquid flavors are used in the comestibles industry to impart flavoring to food and/or beverage products. These are often delivered to food and/or beverage products through the use of delivery systems wherein the liquid flavor can be encapsulated or emulsified prior to introduction with the food and/or beverage product. This imparts oxidative stability to the liquid flavor.

However, currently available delivery systems are not “clean-label.” As such, there remains a need in the art for natural, “clean-label” flavor delivery systems that enable improved oxidative stability of liquid flavors.

### SUMMARY OF ILLUSTRATIVE EMBODIMENTS

Disclosed is a flavor delivery system comprising comminuted seeds, comminuted nuts, or mixtures thereof, and a liquid flavor.

Also disclosed is a method of protecting a liquid flavor from oxidation comprising combining the liquid flavor with comminuted seeds, comminuted nuts, or mixtures thereof.

Also disclosed is a food product comprising an edible base and a flavor delivery system, wherein the flavor delivery system comprises comminuted seeds, comminuted nuts, or mixtures thereof, and a liquid flavor.

Also disclosed is a method of making a food product comprising adding a flavor delivery system to an edible base, wherein the flavor delivery system comprises comminuted seeds, comminuted nuts, or mixtures thereof, and a liquid flavor.

### BRIEF DESCRIPTION OF THE DRAWINGS

FIG. 1 is a photograph of illustrative embodiments of the flavor delivery system with a volatile liquid flavor component present at increasing weight percentages in macadamia butter.

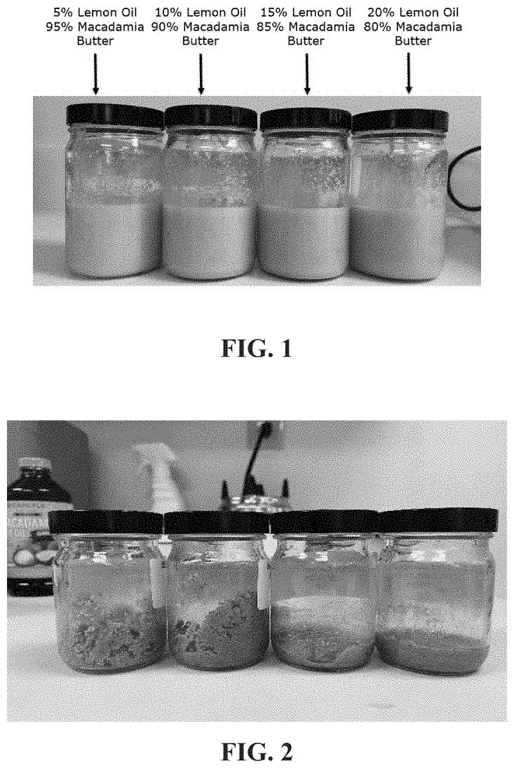

FIG. 2 is a photograph of illustrative embodiments of the flavor delivery system with a volatile liquid flavor component present at increasing weight percentages in ground pumpkin seeds.

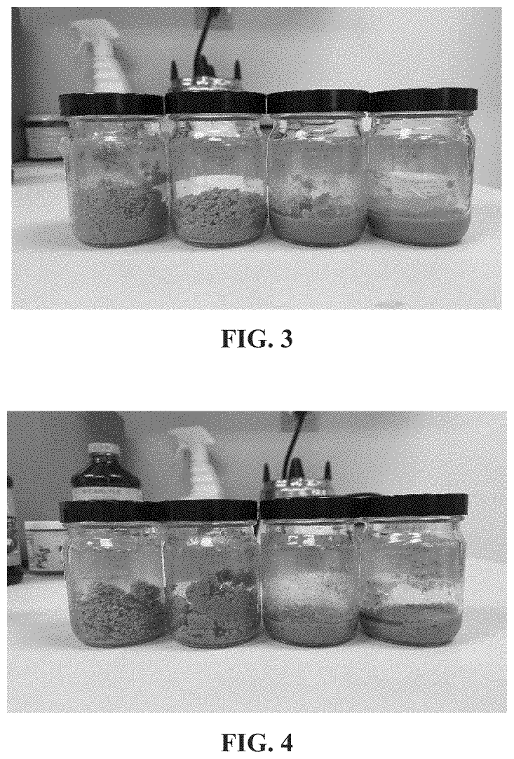

FIG. 3 is a photograph of illustrative embodiments of the flavor delivery system with a volatile liquid flavor component present at increasing weight percentages in ground sunflower seeds.

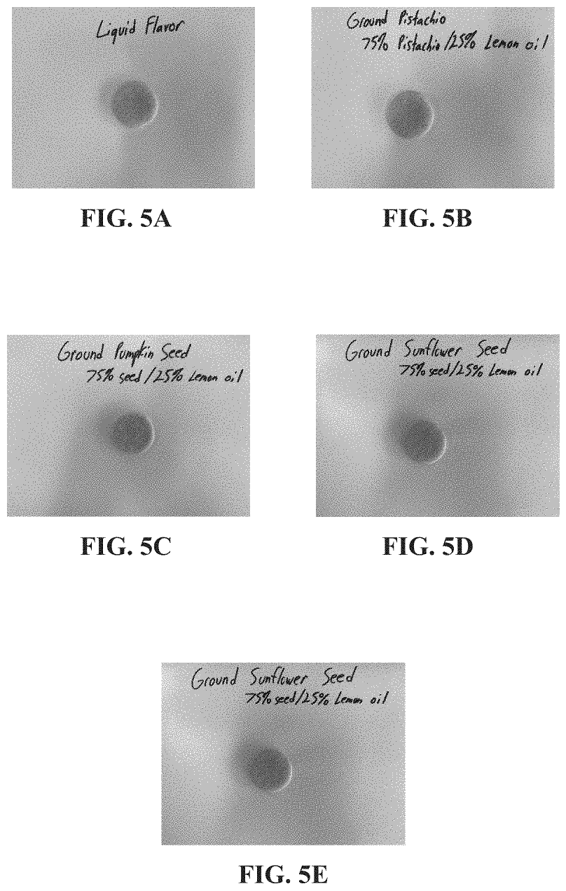

FIG. 4 is a photograph of illustrative embodiments of the flavor delivery system with a volatile liquid flavor component present at increasing weight percentages in ground pistachio nuts.

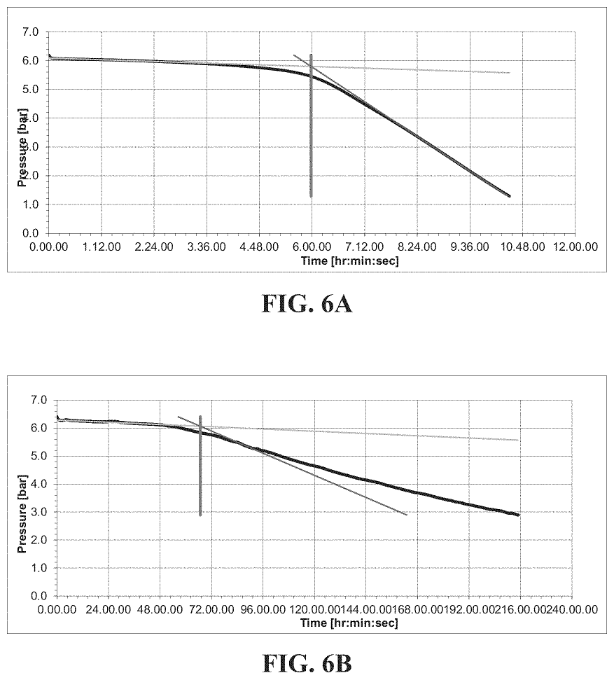

FIGS. 5A-5E are food products produced with the flavor delivery system disclosed herein.

FIGS. 6A-6E are graphs depicting oxygen consumption curves for various illustrative flavor delivery systems.

### DETAILED DESCRIPTION OF ILLUSTRATIVE EMBODIMENTS

The following text sets forth a broad description of numerous different embodiments of the present disclosure. The description is to be construed as illustrative only and does not describe every possible embodiment since describing every possible embodiment would be impractical, if not impossible. It will be understood that any feature, characteristic, component, composition, ingredient, product, step, or methodology described herein can be deleted, combined with, or substituted for, in whole or part, any other feature, characteristic, component, composition, ingredient, product, step, or methodology described herein. Numerous alternative embodiments could be implemented, using either current technology or technology developed after the filing date of this patent application, which would still fall within the scope of the claims.

Each of the terms “comprises,” “comprising,” “comprised of” “has,” “having,” “includes,” “including,” “contains,” “containing,” or any other variation are open-ended terms and are intended to cover a non-exclusive inclusion of elements, features, or steps, such that an article, apparatus, compound, composition, combination, method, or process that “comprises,” “has,” or “includes,” or “contains” a recited list of elements or steps does not include only those elements or steps, but may include other elements or steps not expressly listed, recited, or written in the specification or claims. An element or feature proceeded by the language “comprises . . . a,” “contains . . . a,” “has . . . a,” or “includes . . . a” does not, without more constraints, preclude the existence or inclusion of additional elements or features in the article, apparatus, compound, composition, combination, method, or process that comprises, contains, has, or includes the element or feature.

The terms “a” and “an” are defined as one or more unless expressly stated otherwise or constrained by other language herein. An element or feature proceeded by “a” or “an” may be interpreted as one of the recited element or features, or more than one of the element or features.

The terms “about,” “approximately,” “essentially,” “substantially,” any other variation or version thereof, or any other similar relative term, or similar term of approximation, are defined as being close to as understood by one having ordinary skill in the art. By way of non-limiting, illustrative embodiments, the terms “about,” “approximately,” “essentially,” “substantially,” any other variation or version thereof, or any other similar relative term, or similar term of approximation, are defined to be within 20% of a recited value, or defined to be within 10% of a recited value, or defined to be within 5% of a recited value, or defined to be within 4% of a recited value, or defined to be within 3% of a recited value, or defined to be within 2% of a recited value, or defined to be within 1% of a recited value, or defined to be within 0.5% of a recited value, or defined to be within 0.25% of a recited value, or defined to be within 0.1% of a recited value.

It should be understood that when an amount in weight percent is described in the present disclosure, it is intended that any and every amount within the range, including the end points, is to be considered as having been expressly disclosed. For example, the disclosure of “a range of from about 1 weight percent to about 10 weight percent” is to be read as indicating each and every possible number along the continuum between about 1 and about 10. It is to be understood that the inventors appreciate and understand that any and all data points within the range are to be considered to have been disclosed, and that the inventors have possession of the entire range and all points within the range.

For the avoidance of doubt, preferences, options, particular features and the like indicated for a given aspect, feature or parameter of the disclosure should, unless the context indicates otherwise, be regarded as having been disclosed in combination with any and all other preferences, options, particular features and the like as indicated for the same or other aspects, features and parameters of the invention.

In certain embodiments, the flavor delivery system is “clean-label.” The “clean-label” movement is a consumer driven movement or trend driven by health and nutrition conscious consumers. The term “clean-label” has been adopted by the food industry, consumers, academics, and governmental regulatory agencies. A “clean-label” product is a food product that contains as few ingredients as possible, and which are generally recognized as natural, familiar, and simple ingredients. Consumers and the general public consider, perceive, or recognize the ingredients in the “clean-label” product as being healthy or wholesome, and not artificial, processed, synthetic, or to contain no chemicals.

The flavor delivery system comprises comminuted seeds, comminuted nuts, or mixtures thereof, and at least one liquid flavor. According to certain illustrative embodiments, the at least one liquid flavor of the flavor delivery system comprises at least one non-aqueous liquid flavor. According to other illustrative embodiments, the at least one non-aqueous liquid flavor comprises at least one flavor oil.

Exemplary liquid flavors include, but are not limited to: liquid flavoring oils such as, essential oils, allspice, almond oil, anise oil, asafetida oil, basil oil, bay oil, black pepper oil, caraway seed oil, cardamom seed oil, carrot seed oil, cassia oil, chamomile oil, calamus oil, cedar leaf oil, cinnamon oil, clary sage oil, coconut oil, clove oil, coffee oil, coriander oil, cranberry seed oil, cubeb oil, cumin seed oil, curry leaf oil, dill oil, eucalyptus oil, fennel seed oil, galangal oil, garlic oil, geranium oil, ginger oil, goldenrod oil, grapefruit oil, horseradish oil, Japanese mint oil, juniper berry oil, lavender oil, lemon oil, lemongrass oil, lime oil, mandarin oil, lemon balm oil, mace, mustard oil, nutmeg oil, orange oil, oregano oil, parsley oil, peppermint oil, rosemary oil, sage oil, sassafras oil, spearmint oil, star anise oil, tangerine oil, tarragon oil, tea tree oil, thyme oil, turmeric, wintergreen oil, the like, and mixtures thereof; and/or liquid flavoring agents such as vanilla, coffee, cocoa, lemon, orange, lime, grapefruit, yuzu, sudachi, ginger, the like, and mixtures thereof and/or fruit essences including apple, pear, peach, grape, raspberry, blackberry, gooseberry, blueberry, strawberry, cherry plum, prune, raisin, cola, guarana, neroli, pineapple, apricot, banana, melon, tropical fruits, mango, mangosteen, pomegranate, papaya, the like, and mixtures thereof.

The seed and/or nut component of the present flavor delivery system are comminuted to smaller pieces from a larger seed or nut. As used herein, “comminuted” refers to breaking, grinding, crushing, mashing, mincing, milling, pounding, pulverizing, or like operations until the seeds and/or nuts transition into a fluid or semi-fluid state forming a paste or butter, or are reduced to smaller sizes that are capable of forming pastes or butters upon addition of the liquid flavor to the comminuted seeds and/or nuts. Seed or nut letters are generally prepared by comminuting raw or roasted seeds and/or nuts until they reach a creamy texture. Pastes and/or butters can provide many benefits to food and/or beverage applications. They can generally be described as concentrated emulsions, suspensions, or colloids. One added benefit to paste and/or butter based delivery systems is that they can be prepared in advance.

The seeds and/or nuts may be raw, treated, or a combination thereof. According to certain embodiments, treated comprises roasting or toasting the seeds and/or nuts.

The seeds used to prepare the paste and/or butter utilized in the flavor delivery system can include, but are not limited to: millet, pumpkin, safflower, sunflower, sesame, flaxseed, chia, hemp, poppy, chickpea, soybean, melons, berries, quinoa, sorghum, teff, canola, rye, amaranth, barley, rice, spelt, wheat, and combinations thereof.

The nuts used to prepare the paste and/or butter utilized in the flavor delivery system can include, but are not limited to: coconut, pine nuts, peanuts, macadamia nuts, pistachio nuts, almonds, beech, Brazil, candlenut, cashews, chestnuts, hazel nuts, hickory, kola, pecans, walnuts, and mixtures thereof.

According to certain illustrative embodiments, the flavor delivery system may comprise from about 5 to about 25 percent of the at least one liquid flavor and from about 75 to about 95 percent of a seed paste.

According to certain illustrative embodiments, the flavor delivery system may comprise from about 5 to about 25 percent of the at least one liquid flavor and from about 75 to about 95 percent of a seed butter.

According to certain illustrative embodiments, the flavor delivery system may comprise from about 5 to about 25 percent of the at least one liquid flavor and from about 75 to about 95 percent of a nut paste.

According to certain illustrative embodiments, the flavor delivery system may comprise from about 5 to about 25 percent of the at least one liquid flavor and from about 75 to about 95 percent of a nut butter.

According to certain illustrative embodiments, the flavor delivery system may comprise from about 5 to about 25 percent of the at least one liquid flavor and from about 75 to about 95 percent of a paste comprising a blend of comminuted seeds and nuts.

According to certain illustrative embodiments, the flavor delivery system may comprise from about 5 to about 25 percent of the at least one liquid flavor and from about 75 to about 95 percent of a butter comprising a blend of comminuted seeds and nuts.

In certain embodiments, other optional edible components can be included in the flavor delivery system including, but not limited to colorants, thickeners, stabilizers, electrolytes, anti-foaming agents, emulsifiers, preservatives, gums, starches, dextrins, vitamins, minerals, salts, sweeteners, and combinations thereof.

In certain embodiments, seed or nut oils that are the same or different than the seeds and/or nuts selected for the flavor delivery system (e.g., vegetable oils, sunflower oil, safflower oil, flaxseed oil, olive oil, grapeseed oil, and the like, and mixtures thereof), honeys, sweeteners, and mixtures thereof.

In certain embodiments, the flavor delivery system may contain an effective amount of a solidifying or gelling agent to effect solidification of the butter to form a semi-solid or solid consistency. Without limitation, solidifying agents that are useful include: gelatin, pectin, guar gum, xanthan gum, locust bean gum, gum arabic, cellulose gums, edible agar, tragacanth, carrageenan, alginate, modified food starch, the like, and mixtures thereof.

In certain embodiments, the flavor delivery system further comprises nutritionally effective amounts of including, but not limited to, vitamins and minerals. In certain embodiments, the delivery system can contain multiple different vitamins, or multiple different minerals, or both vitamins and minerals.

In certain embodiments, the flavor delivery system further comprises a preservative. “Clean-label” preservatives can include, but are not limited to, wheat, starch, cultured brown rice, dextrose, whey or corn solids, vinegar, citrus juices (e.g., lemon, lime, orange, grapefruit, etc.), the like, and mixtures thereof.

In certain embodiments, the flavor delivery system is incorporated into comestible products. The comestible products can include, but are not limited to, bakery products (e.g., breads, cookies, crackers, cakes, pastries, pies, puddings, etc.), condiments, sauces, salad dressings, marinades, cooking ingredients (e.g., soups, stews, chili, hummus, etc.), confectionary goods, granola, protein bars, cereal and/or snack food products, and dairy products (e.g., ice cream, custard, milk, milk shakes, cheese, smoothies, yogurts, cottage cheese, pudding, sour cream, cream cheese, etc.). These products are intended for human consumption, but the flavor delivery system can also be utilized for animal foods, snacks, and treats.

As used herein, “protecting” refers to delaying the onset of oxidation of the liquid flavor when compared to the liquid flavor's onset of oxidation alone.

Illustrative embodiments of the disclosure include:

A flavor delivery system comprising comminuted seeds, comminuted nuts, or mixtures thereof, and a liquid flavor. The comminuted seeds, comminuted nuts, or mixtures thereof may be ground to form a paste or butter.

The comminuted seeds may be selected from the group consisting of: pumpkin seeds, sunflower seeds, sesame seeds, flax seeds, chia seeds, hemp seeds, poppy seeds, chickpea seeds, and soybean seeds. The comminuted nuts may be selected from the group consisting of: pine nuts, peanuts, macadamia nuts, pistachio nuts, almonds, cashews, chestnuts, hazelnuts, pecans, and walnuts.

The liquid flavor may comprise a liquid flavoring oil. The liquid flavoring oil may comprise an essential oil.

In one embodiment of the flavor delivery system, the ratio of the liquid flavor to the comminuted seeds, comminuted nuts, or mixtures thereof is about 10:90 to about 25:75. In certain embodiments, the comminuted seeds, comminuted nuts, or mixtures thereof are sunflower seeds, the liquid flavor is a liquid flavoring oil, and the ratio of the liquid flavoring oil to the sunflower seeds is 25:75. In other embodiments, the comminuted seeds, comminuted nuts, or mixtures thereof are macadamia nuts, the liquid flavor is a liquid flavoring oil, and the ratio of the liquid flavoring oil to the macadamia nuts is 10:90. In other embodiments, the comminuted seeds, comminuted nuts, or mixtures thereof are pumpkin seeds, the liquid flavor is a liquid flavoring oil, and the ratio of the liquid flavoring oil to the pumpkin seeds is about 20:80 to about 25:75. In other embodiments, the comminuted seeds, comminuted nuts, or mixtures thereof are pistachio nuts, the liquid flavor is a liquid flavoring oil, and the ratio of the liquid flavoring oil to the pistachio nuts is about 20:80 to about 25:75.

The flavor delivery system comprises oxidative stability greater than the oxidative stability of the liquid flavor alone.

The flavor delivery system may further comprise a preservative. The flavor delivery system may also be clean-label.

Also provided is a food product comprising an edible base and the flavor delivery system. The edible base of the food product includes all of the components or ingredients desired or required to prepare a finished food product, other than the flavor delivery system.

Also provided is a method of protecting a liquid flavor from oxidation comprising combining the liquid flavor with comminuted seeds, comminuted nuts, or mixtures thereof.

The comminuted seeds utilized in the method can be selected from the group consisting of: pumpkin seeds, sunflower seeds, sesame seeds, flax seeds, chia seeds, hemp seeds, poppy seeds, chickpea seeds, soybean seeds, and mixtures thereof. The comminuted nuts utilized in the method can be selected from the group consisting of: pine nuts, peanuts, macadamia nuts, pistachio nuts, almonds, cashews, chestnuts, hazelnuts, pecans, walnuts, and mixtures thereof.

The liquid flavor in the method can comprise a liquid flavoring oil. The liquid flavoring oil can comprise an essential oil.

The method of preparing the flavor delivery system includes infusing or loading the seed and/or nut butter or paste with a suitable amount of at least one flavor oil to be protected from oxidation. The flavor oil may be loaded into the butter or paste by hand mixing or mechanical mixing. For example, and without limitation, the flavor oil may be loaded into the butter or paste via mechanical mixing with a suitable overhead mixer. The flavor oil may be loaded into the butter or paste with mixing at room temperature or elevated temperatures that do not degrade the butter or paste, or the at least one flavor oil.

Also disclosed is a method of making a food product. The method comprises adding a flavor delivery system to an edible base, wherein the flavor delivery system comprises comminuted seeds, comminuted nuts, or mixtures thereof, and a liquid flavor.

Also disclosed is a use of comminuted seeds, comminuted nuts, or mixtures thereof to increase the oxidative stability of a liquid flavor.

The inventor surprisingly and unexpectedly found that the delivery system disclosed herein provided oxidative stability when employed at the following ratios of liquid flavoring to seed/nut component.

There are a number of methods are well known to those skilled in the art for determining oxidative stability. In the present embodiments, the OXITEST Oxidation test reactor provided by Velp Scientifica, Italy was used to measure oxidative stability. The end point, or induction point, is determined according to ASTM D942, IP method. The longer the induction point (measured in hours), the more stable the delivery system. In one embodiment, the induction point for a delivery system according to the present disclosure is greater than 50 hours; in another embodiment the induction point is greater than 100 hours; in another embodiment the induction point is greater than 150 hours; in another embodiment, the induction point is greater than 200 hours; in another embodiment the induction point is greater than 250 hours; and in another embodiment the induction point is greater than 300 hours.

TABLE 1
Ratios of Liquid Flavor to Comminuted Seed/Nut Component

| Ground Seed/Nut Component | Ratio |
|---|---|
| Pumpkin Seeds | 20:80 |
| Pumpkin Seeds | 25:75 |
| Sunflower Seeds | 25:75 |
| Pistachio Nuts | 20:80 |
| Pistachio Nuts | 25:75 |

The following examples are given solely for the purpose of illustration and are not to be construed as limitations of the present disclosure, as many variations of the disclosure are possible without departing from the spirit and scope of the present disclosure.

### Example 1: Liquid Flavoring Oil (Lemon Oil) and Macadamia Butter

Four samples with various ratios of liquid flavoring oil (lemon oil) and macadamia butter were prepared. The first sample was prepared utilizing 5% by weight of the liquid flavoring oil and 95% by weight of macadamia butter. The second sample was prepared utilizing 10% by weight of the liquid flavoring oil and 90% by weight of macadamia butter. The third sample was prepared utilizing 15% by weight of the liquid flavoring oil and 85% by weight of macadamia butter. The fourth sample was prepared utilizing 20% by weight of the liquid flavoring oil and 80% by weight of macadamia butter. The samples were mixed with an overhead mixer at room temperature and permitted to rest for 76 days prior to being photographed.

### Example 2: Liquid Flavoring Oil (Lemon Oil) and Ground Pumpkin Seeds

Four samples with various ratios of liquid flavoring oil (lemon oil) and ground pumpkin seeds were prepared. The first sample was prepared utilizing 15% by weight of the liquid flavoring oil and 85% by weight of ground pumpkin seeds. The second sample was prepared utilizing 20% by weight of the liquid flavoring oil and 80% by weight of ground pumpkin seeds. The third sample was prepared utilizing 25% by weight of the liquid flavoring oil and 75% by weight of ground pumpkin seeds. The fourth sample was prepared utilizing 30% by weight of the liquid flavoring oil and 70% by weight of ground pumpkin seeds. The samples were mixed with a blender at room temperature and permitted to rest for 76 days prior to being photographed.

### Example 3: Liquid Flavoring Oil (Lemon Oil) and Ground Sunflower Seeds

Four samples with various ratios of liquid flavoring oil (lemon oil) and ground sunflower seeds were prepared. The first sample was prepared utilizing 15% by weight of the liquid flavoring oil and 85% by weight of ground sunflower seeds. The second sample was prepared utilizing 20% by weight of the liquid flavoring oil and 80% by weight of ground sunflower seeds. The third sample was prepared utilizing 25% by weight of the liquid flavoring oil and 75% by weight of ground sunflower seeds. The fourth sample was prepared utilizing 30% by weight of the liquid flavoring oil and 70% by weight of ground sunflower seeds. The samples were mixed with a blender at room temperature and permitted to rest for 76 days prior to being photographed.

### Example 4: Liquid Flavoring Oil (Lemon Oil) and Ground Pistachio Seeds

Four samples with various ratios of liquid flavoring oil (lemon oil) and ground pistachio seeds were prepared. The first sample was prepared utilizing 15% by weight of the liquid flavoring oil and 85% by weight of ground pistachio seeds. The second sample was prepared utilizing 20% by weight of the liquid flavoring oil and 80% by weight of ground pistachio seeds. The third sample was prepared utilizing 25% by weight of the liquid flavoring oil and 75% by weight of ground pistachio seeds. The fourth sample was prepared utilizing 30% by weight of the liquid flavoring oil and 70% by weight of ground pistachio seeds. The samples were mixed with a blender at room temperature and permitted to rest for 76 days prior to being photographed.

### Example 5: Preparation of Food Products Through Use of Delivery System

One food product was prepared without the use of the flavor delivery system. Four food products were prepared with the use of the flavor delivery system, in this case, sugar cookies.

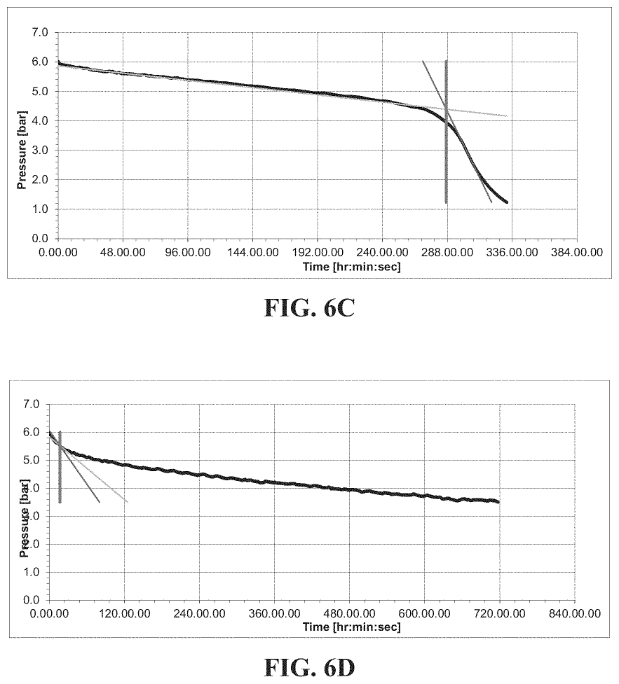

The first sugar cookie was prepared without the use of the delivery system. FIG. 5A depicts a sugar cookie prepared without the use of the delivery system. The sugar cookie was prepared in accordance with the following recipe:

TABLE 2
Liquid Flavoring Oil

| Component | Grams | % by weight |
|---|---|---|
| All-Purpose Flour | 129.36 | 43.12% |
| Water | 17.25 | 5.75% |
| Baking Soda | 1.29 | 0.43% |
| Sugar | 61.59 | 20.53% |
| Salt, 40 Mesh | 1.35 | 0.45% |
| Non-Fat Dried Milk | 1.95 | 0.65% |
| Shortening | 71.70 | 23.9% |
| Egg | 11.01 | 3.67% |
| Liquid Flavoring Oil | 4.50 | 1.5% |
| Total | 300 | 100% |

Illustrative delivery systems utilizing at least one of macadamia butter, pistachio butter, pumpkin butter, and sunflower butter were prepared according to the following. These delivery systems were used to produce the sugar cookies of FIGS. 5B-5E. For the sugar cookies of FIGS. 5B-5E, each recipe contained a total of 6 grams of the corresponding flavor delivery system. The 6 grams of the delivery system accounted for 1.5 grams of liquid flavoring oil and 4.5 grams of the butter component.

The second sugar cookie was prepared utilizing the flavor delivery system including liquid flavoring oil (lemon oil) and macadamia butter. FIG. 5B depicts a sugar cookie prepared in accordance with this embodiment of the flavor delivery system. The sugar cookie was prepared in accordance with the following recipe:

TABLE 3
Macadamia Butter Flavor Delivery System

| Component | Grams | % by weight |
|---|---|---|
| All-Purpose Flour | 127.86 | 42.62% |
| Water | 17.25 | 5.75% |
| Baking Soda | 1.29 | 0.43% |
| Sugar | 61.59 | 20.53% |
| Salt, 40 Mesh | 1.35 | 0.45% |
| Non-Fat Dried Milk | 1.95 | 0.65% |
| Shortening | 71.70 | 23.9% |
| Egg | 11.01 | 3.67% |
| Macadamia Butter Flavor Delivery System | 6* | 2% |
| Total | 300 | 100% |

The third sugar cookie was prepared utilizing the flavor delivery system including liquid flavoring oil (lemon oil) and ground pistachio nuts. FIG. 5C depicts a sugar cookie prepared in accordance with this embodiment of the flavor delivery system. The sugar cookie was prepared in accordance with the following recipe:

TABLE 4
Ground Pistachio Flavor Delivery System

| Component | Grams | % by weight |
|---|---|---|
| All-Purpose Flour | 127.86 | 42.62% |
| Water | 17.25 | 5.75% |
| Baking Soda | 1.29 | 0.43% |
| Sugar | 61.59 | 20.53% |
| Salt, 40 Mesh | 1.35 | 0.45% |
| Non-Fat Dried Milk | 1.95 | 0.65% |
| Shortening | 71.70 | 23.9% |
| Egg | 11.01 | 3.67% |
| Pistachio Flavor Delivery System | 6* | 2% |
| Total | 300 | 100% |

The fourth sugar cookie was prepared utilizing the flavor delivery system including liquid flavoring oil (lemon oil) and ground pumpkin seeds. FIG. 5D depicts a sugar cookie prepared in accordance with this embodiment of the flavor delivery system. The sugar cookie was prepared in accordance with the following recipe:

TABLE 5
Ground Pumpkin Seed Flavor Delivery System

| Component | Grams | % by weight |
|---|---|---|
| All-Purpose Flour | 127.86 | 42.62% |
| Water | 17.25 | 5.75% |
| Baking Soda | 1.29 | 0.43% |
| Sugar | 61.59 | 20.53% |
| Salt, 40 Mesh | 1.35 | 0.45% |
| Non-Fat Dried Milk | 1.95 | 0.65% |
| Shortening | 71.70 | 23.9% |
| Egg | 11.01 | 3.67% |
| Pumpkin Seed Flavor Delivery System | 6* | 2% |
| Total | 300 | 100% |

The fifth sugar cookie was prepared utilizing the flavor delivery system including liquid flavoring oil (lemon oil) and ground sunflower seeds. FIG. 5E depicts a sugar cookie prepared in accordance with this embodiment of the flavor delivery system. The sugar cookie was prepared in accordance with the following recipe:

TABLE 6
Ground Sunflower Seed Flavor Delivery System

| Component | Grams | % by weight |
|---|---|---|
| All-Purpose Flour | 127.86 | 42.62% |
| Water | 17.25 | 5.75% |
| Baking Soda | 1.29 | 0.43% |
| Sugar | 61.59 | 20.53% |
| Salt, 40 Mesh | 1.35 | 0.45% |
| Non-Fat Dried Milk | 1.95 | 0.65% |
| Shortening | 71.70 | 23.9% |
| Egg | 11.01 | 3.67% |
| Sunflower Seed Flavor Delivery System | 6* | 2% |
| Total | 300 | 100% |

### Example 6: Oxidative Stability Through Use of Delivery System

A clear benefit to oxidative stability was derived through the utilization of the flavor delivery system. A total of five oxygen consumption curves were produced. One oxygen consumption curve relates to the liquid flavoring oil (lemon oil) alone. Four oxygen consumption curves relate to various illustrative embodiments of the flavor delivery system. To measure the oxidative stability, an OXITEST system was utilized. The OXITEST system subjects samples to high oxidative stress to evaluate resistance to fat oxidation. The OXITEST system produces results through the use of oxygen consumption curves and induction periods. An induction period is the time required to reach the onset of oxidation. The longer the induction period, the higher the oxidative stability of the sample. The temperature of the OXITEST system was set at 70° C. and the starting oxygen pressure was 6 bar.

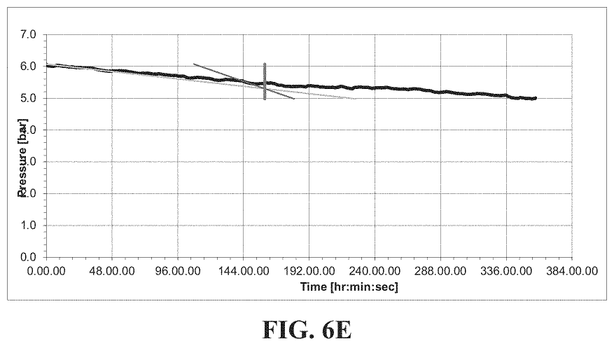

For the first sample, the liquid flavoring oil (lemon oil) alone was measured. The induction point of the liquid flavoring oil was at approximately 5 hours and 59 minutes. FIG. 6A depicts the oxygen consumption curve of the liquid flavoring oil (lemon oil) alone.

For the second sample, the delivery system was prepared utilizing a ratio of 10:90 liquid flavoring oil (lemon oil) to macadamia butter was measured. The induction point of the delivery system was at approximately 67 hours and 38 minutes. FIG. 6B depicts the oxygen consumption curve of the delivery system in accordance with this embodiment.

For the third sample, the delivery system was prepared utilizing a ratio of 25:75 liquid flavoring oil (lemon oil) and ground sunflower seeds. The induction point of the delivery system was at approximately 287 hours and 50 minutes. FIG. 6C depicts the oxygen consumption curve of the delivery system in accordance with this embodiment.

For the fourth sample, the delivery system was prepared utilizing a ratio of 25:75 liquid flavoring oil (lemon oil) and ground pistachio nuts. An induction point could not be generated. This suggests high resistance to oxidation. FIG. 6D depicts the oxygen consumption curve of the delivery system in accordance with this embodiment.

For the fifth sample, the delivery system was prepared utilizing a ratio of 25:75 liquid flavoring oil (lemon oil) and ground pumpkin seeds. An induction point could not be generated. This suggests high resistance to oxidation. FIG. 6E depicts the oxygen consumption curve of the delivery system in accordance with this embodiment.

When compared to the onset of oxidation of the liquid flavoring oil (lemon oil) alone as measured by the OXITEST system, the flavor delivery systems resulted in a delayed induction point, thus indicating greater oxidative stability.

### Example 7: Induction Points of Flavor Delivery Systems

The first sample (10:90 ratio of liquid flavoring oil (lemon oil) to macadamia butter) and the second sample (25:75 ratio of liquid flavoring oil (lemon oil) to sunflower seeds) used in Example 6 were measured using the OXITEST system an additional two times for a total of three measurements per sample. The induction points and standard deviations are set forth below.

TABLE 7
Induction Points of Pastes containing Liquid Flavoring Oil

| | Induction Point | Standard Deviation |
|---|---|---|
| Sample | (hours) (n = 3) | (hours) |
| 10% Liquid Flavoring Oil | 80.79 | 3.05 |
| 90% Macadamia Butter | | |
| 25% Liquid Flavoring Oil | 320.56 | 40.37 |
| 75% Ground Sunflower Seeds | | |

The seed and/nut butter or paste acts to encapsulate the liquid flavor of the flavor delivery system to provide moisture protections to the flavor and to protect the liquid flavor from oxidation. The seed and/or nut butter or paste permits release of the liquid flavor in a controllable manner under desired conditions.

The present embodiments provide a natural paste-based flavor delivery system for delivering a liquid flavor to a consumable and which provides oxidative stability to the liquid flavor and is considered to be a clean-label product.

It is to be understood that other similar embodiments may be used or modifications and additions may be made to the described embodiments for performing the same function. Furthermore, the various illustrative embodiments may be combined to produce the desired results. Therefore, the flavor delivery system, the method of protecting a liquid flavor from oxidation, and the method of making a food product, should not be limited to any single embodiment, but rather construed in breadth and scope in accordance with the recitation of the appended claims. It will be understood that the embodiments described herein are merely exemplary, and that one skilled in the art may make variations and modifications without departing from the spirit and scope of the invention. All such variations and modifications are intended to be included within the scope of the invention as described hereinabove. Further, all embodiments disclosed are not necessarily in the alternative, as various embodiments of the invention may be combined to provide the desired result.

1. A flavor delivery system comprising:
comminuted seeds, comminuted nuts, or mixtures thereof; and
a liquid flavor.

2. The flavor delivery system of claim 1, wherein the comminuted seeds, comminuted nuts, or mixtures thereof are ground to form a paste or butter.

3. The flavor delivery system of claim 1, wherein the comminuted seeds are selected from the group consisting of: pumpkin seeds, sunflower seeds, sesame seeds, flax seeds, chia seeds, hemp seeds, poppy seeds, chickpea seeds, and soybean seeds.

4. The flavor delivery system of claim 1, wherein the comminuted nuts are selected from the group consisting of: pine nuts, peanuts, macadamia nuts, pistachio nuts, almonds, cashews, chestnuts, hazelnuts, pecans, and walnuts.

5. The flavor delivery system of claim 1, wherein the liquid flavor comprises a liquid flavoring oil.

6. The flavor delivery system of claim 5, wherein the liquid flavoring oil comprises an essential oil.

7. The flavor delivery system of claim 1, wherein the ratio of the liquid flavor to the comminuted seeds, comminuted nuts, or mixtures thereof is about 10:90 to about 25:75.

8. The flavor delivery system of claim 1, wherein the comminuted seeds, comminuted nuts, or mixtures thereof is sunflower seeds, the liquid flavor is a liquid flavoring oil, and the ratio of the liquid flavoring oil to the sunflower seeds is 25:75.

9. The flavor delivery system of claim 1, wherein the comminuted seeds, comminuted nuts, or mixtures thereof is macadamia nuts, the liquid flavor is a liquid flavoring oil, and the ratio of the liquid flavoring oil to the macadamia nuts is 10:90.

10. The flavor delivery system of claim 1, wherein the comminuted seeds, comminuted nuts, or mixtures thereof is pumpkin seeds, the liquid flavor is a liquid flavoring oil, and the ratio of the liquid flavoring oil to the pumpkin seeds is about 20:80 to about 25:75.

11. The flavor delivery system of claim 1, wherein the comminuted seeds, comminuted nuts, or mixtures thereof is pistachio nuts, the liquid flavor is a liquid flavoring oil, and the ratio of the liquid flavoring oil to the pistachio nuts is about 20:80 to about 25:75.

12. The flavor delivery system of claim 1, wherein the oxidative stability of the flavor delivery system is greater than the oxidative stability of the liquid flavor alone.

13. The flavor delivery system of claim 1, further comprising a preservative.

14. The flavor delivery system of claim 1, wherein the flavor delivery system is clean-label.

15. A food product comprising an edible base and the flavor delivery system of claim 1.

16. A method of protecting a liquid flavor from oxidation comprising combining the liquid flavor with comminuted seeds, comminuted nuts, or mixtures thereof.

17. The method of claim 16, wherein the comminuted seeds are selected from the group consisting of: pumpkin seeds, sunflower seeds, sesame seeds, flax seeds, chia seeds, hemp seeds, poppy seeds, chickpea seeds, and soybean seeds.

18. The method of claim 16, wherein the liquid flavor comprises a liquid flavoring oil.

19. The method of claim 18, wherein the liquid flavoring oil comprises an essential oil.

20. A method of making a food product comprising:
adding a flavor delivery system to an edible base, wherein the flavor delivery system comprises comminuted seeds, comminuted nuts, or mixtures thereof, and a liquid flavor.
